(19) United States
(12) Patent Application Publication
(10) Pub. No.: US 2015/0371312 A1
(43) Pub. Date: Dec. 24, 2015

(54) INFORMATION PROVIDING APPARATUS, INFORMATION PROVIDING METHOD, PROGRAM AND RECORDING MEDIUM

(71) Applicant: RAKUTEN, INC., Shinagawa-ku, Tokyo (JP)

(72) Inventor: Mikiko MATSUURA, Tokyo (JP)

(73) Assignee: RAKUTEN, INC., Tokyo (JP)

(21) Appl. No.: 14/765,017

(22) PCT Filed: Oct. 30, 2013
(86) PCT No.: PCT/JP2013/079384

§ 371 Date: Jul. 31, 2015

(51) Int. Cl. G06Q 30/06

(52) U.S. Cl. CPC G06Q 30/0625

(57) ABSTRACT

An obtainer (101) sorts, when a keyword is entered, attributes associated with commercial items matching the keyword in descending order of the number of commercial items associated with the attributes among the commercial items matching the keyword to obtain an attribute that is equal to or higher than a predetermined ranking. A determiner (102) determines whether or not the attribute obtained by the obtainer (101) satisfies a predetermined condition. A presenter (103) presents the commercial item associated with the attribute that is equal to or higher than the predetermined ranking among the commercial items matching the keyword when the determiner determines that the attribute obtained by the obtainer (101) satisfies the predetermined condition.

### TECHNICAL FIELD

The present disclosure relates to an information providing apparatus, an information providing method, a program and a non-transitory recording medium which can present commercial items matching an input keyword.

### BACKGROUND ART

Conventionally, pieces of information related to commercial items handled on shopping sites and auction sites over the Internet, for example, pieces of information on the name of a commercial item, the name of a category of the commercial item, and the explanation texts thereof are registered in a commercial-item database that manages all commercial items handled on those sites by users who sell the commercial items or place those items on an auction (see, for example, Patent Literature 1).

### CITATION LIST

### Patent Literature

Patent Literature 1: Unexamined Japanese Patent Application Kokai Publication No. 2010-113390

### SUMMARY OF INVENTION

### Technical Problem

When information on a commercial item is registered in the commercial-item database, it is necessary that such information is properly input by a user who sells this commercial item or places this commercial item on an auction. However, such information is input manually, and thus there is a possibility that the information is input falsely due to a typographical error or by intention. For example, there is a possibility that, as to a commercial item which requires a specific credential or license for sale, a user who has no such credential or license inputs false commercial item name and category for the purpose of deceiving a manager who manages pieces of information on commercial items registered in the commercial-item database, and of registering and selling the commercial item. When false information on a commercial item is registered in the commercial-item database as explained above, if a user who wants to purchase this commercial item searches the commercial item from the commercial-item database with a keyword related to the commercial item, there is a possibility that a falsely registered commercial item is presented as a search result, causing the user to misidentify the commercial item.

The present disclosure has been made in view of the aforementioned circumstances, and it is an objective of the present disclosure to provide an information providing apparatus, an information providing method, a program, and a non-transitory recording medium which can prevent a presentation of, to a user, a commercial item having false information input thereof.

### Solution to Problem

In order to accomplish the above objective, an information providing apparatus according to the first aspect of the present disclosure includes: an obtainer that sorts, when a keyword is entered, attributes associated with commercial items matching the keyword in descending order of the number of commercial items associated with the attributes among the commercial items matching the keyword to obtain an attribute that is equal to or higher than a predetermined ranking; a determiner that determines whether or not the obtained attribute satisfies a predetermined condition; and a presenter that presents the commercial item associated with the attribute that is equal to or higher than the predetermined ranking among the commercial items matching the keyword when the determiner determines that the obtained attribute satisfies the predetermined condition.

In the information providing apparatus of the aforementioned aspect, when the commercial item associated with the obtained attribute requires a specific credential to sell the commercial item, the determiner determines that the attribute that is equal to or higher than the predetermined ranking satisfies the predetermined condition.

In the information providing apparatus of the aforementioned aspect, the presenter does not present the commercial item of a seller that does not have the specific credential among the commercial items matching the keyword.

In the information providing apparatus of the aforementioned aspect, the presenter does not present the commercial items associated with the attributes other than the attribute that is equal to or higher than the predetermined ranking among the obtained commercial items.

In the information providing apparatus of the aforementioned aspect, the attribute indicates a category where the commercial item belongs.

In the information providing apparatus of the aforementioned aspect, the attribute indicates a seller of the commercial item.

An information providing method according to a second aspect of the present disclosure is executed by an information processing apparatus including an obtainer, a determiner, and a presenter, and the method includes: an obtaining step of causing the obtainer to sort, when a keyword is entered, attributes associated with commercial items matching the keyword in descending order of the number of commercial items associated with the attributes among the commercial items matching the keyword to obtain an attribute that is equal to or higher than a predetermined ranking; a determining step of causing the determiner to determine whether or not the obtained attribute satisfies a predetermined condition; and a presenting step of causing the presenter to present the commercial item associated with the attribute that is equal to or higher than the predetermined ranking among the commercial items matching the keyword when the determiner determines that the obtained attribute satisfies the predetermined condition.

A program according to a third aspect of the present disclosure causes a computer to function as: an obtainer that sorts, when a keyword is entered, attributes associated with commercial items matching the keyword in descending order of the number of commercial items associated with the attributes among the commercial items matching the keyword to obtain an attribute that is equal to or higher than a predetermined ranking; a determiner that determines whether or not the obtained attribute satisfies a predetermined condition; and a presenter that presents the commercial item associated with the attribute that is equal to or higher than the predetermined ranking among the commercial items matching the keyword when the determiner determines that the obtained attribute satisfies the predetermined condition.

A computer-readable non-transitory recording medium according to a fourth aspect of the present disclosure has stored therein a program that causes a computer to function as: an obtainer that sorts, when a keyword is entered, attributes associated with commercial items matching the keyword in descending order of the number of commercial items associated with the attributes among the commercial items matching the keyword to obtain an attribute that is equal to or higher than a predetermined ranking; a determiner that determines whether or not the obtained attribute satisfies a predetermined condition; and a presenter that presents the commercial item associated with the attribute that is equal to or higher than the predetermined ranking among the commercial items matching the keyword when the determiner determines that the obtained attribute satisfies the predetermined condition.

### Advantageous Effects of Invention

According to the present disclosure, it becomes possible to prevent a presentation of, to a user, a commercial item having false information thereof input.

### BRIEF DESCRIPTION OF DRAWINGS

FIG. 1 is a diagram illustrating a structure of an information processing system according to an embodiment;

FIG. 2 is a diagram illustrating example data stored in a commercial-item database;

FIG. 3 is a schematic block diagram illustrating a hardware configuration of an information providing apparatus;

FIG. 4 is a schematic block diagram illustrating a functional configuration of the information providing apparatus;

FIG. 5 is a diagram illustrating an example of a commercial-item search page;

FIG. 6 is a diagram illustrating an example result of sorting categories by an obtainer with the number of commercial items;

FIG. 7 is a diagram illustrating an example of a search result page; and

FIG. 8 is an example flowchart of a commercial-item presenting process.

### DESCRIPTION OF EMBODIMENTS

A detailed explanation will now be given of an embodiment of the present disclosure with reference to the drawings.

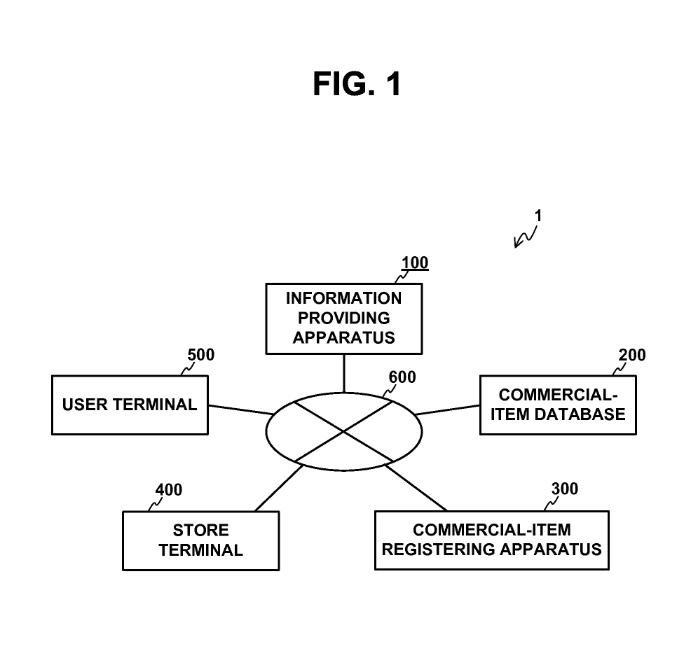

FIG. 1 illustrates a structure of an information processing system 1 according to an embodiment of the present disclosure. The information processing system 1 is a system that manages commercial items which are on sale on online shopping sites. As illustrated in FIG. 1, the information managing system 1 includes an information providing apparatus 100, a commercial-item database 200, a commercial-item registering apparatus 300, a store terminal 400, and a user terminal 500, and respective apparatuses are communicable one another via the Internet 600.

The information providing apparatus 100 is a computer system that provides various webpages of an online shopping site, searches commercial items from the commercial-item database 200, and accepts an order, in response to a request from the user terminal 500.

The commercial-item database 200 is an apparatus that stores pieces of information related to commercial items that are on sale on the store. More specifically, the commercial-item database 200 stores, for each commercial item, the attribute thereof. In this case, the attribute of a commercial item is a feature thereof that includes, for example, a category to which the commercial item belongs, and the seller (store) of the commercial item.

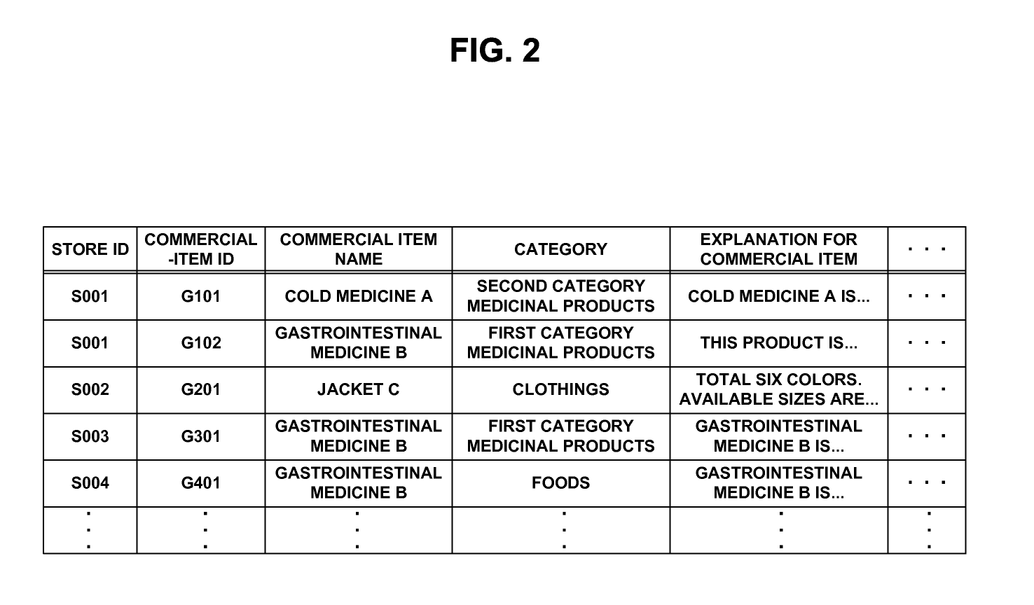

FIG. 2 illustrates example data stored in the commercial-item database 200. In the example case illustrated in FIG. 2, the commercial-item database 200 stores, for each commercial item, a store ID of the store which sells the commercial item, an item ID of the commercial item, the name of the commercial item, a category to which the commercial item belongs, and the explanation of the commercial item. Various data stored in the commercial-item database 200 is registered, updated or deleted by the commercial-item registering apparatus 300 based on information obtained from the store terminal 400.

The commercial-item registering apparatus 300 is a computer system which checks information on a commercial item input from the store where the commercial item is on sale, and registers the input information in the commercial-item database 200. More specifically, the commercial-item registering apparatus 300 obtains information on a commercial item input from the store through the store terminal 400. Next, the commercial-item registering apparatus 300 registers the obtained information in the commercial-item database 200.

The store terminal 400 is a computer operated at the store which sells commercial items on an online shopping site. More specifically, the store terminal 400 transmits, to the commercial-item registering apparatus 300, information, input by the user, on a commercial item to be registered in the commercial-item database 200. Note that the store terminal 400 may transmit, to the commercial-item registering apparatus 300, information on a commercial item to be registered in the commercial-item database 200 through an FTP (File Transfer Protocol) from a system built in the store. In FIG. 1, there is only one store terminal 400 presented, but the number of the store terminals 400 is not limited to this number.

The user terminal 500 is a computer operated by the user who browses, searches, and purchases a commercial item through the online shopping site. In FIG. 1, there is only one user terminal 500 presented, but the number of user terminals 500 is not limited to this number.

Next, a structure of the information providing apparatus 100 will be explained in more detail.

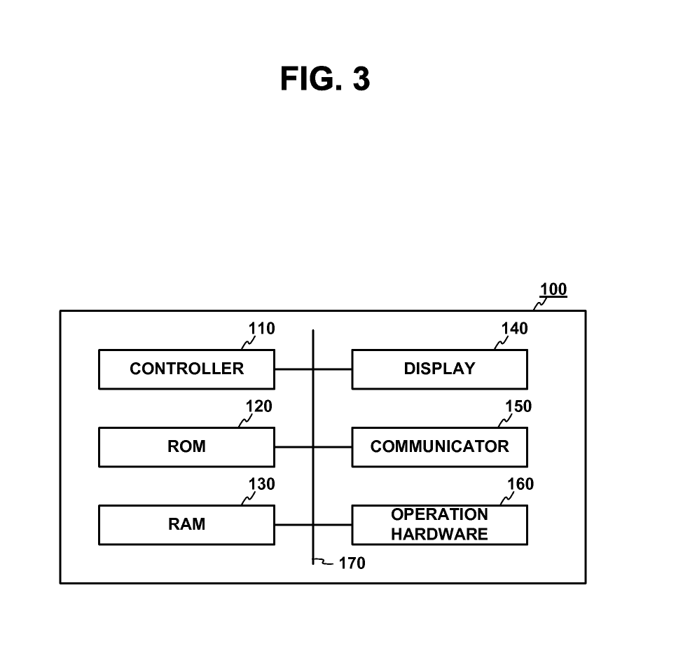

FIG. 3 is a schematic block diagram illustrating a hardware configuration of the information providing apparatus 100. As illustrated in FIG. 3, the information providing apparatus 100 includes a controller 110, a ROM (Read Only Memory) 120, a RAM (Random Access Memory) 130, a display 140, a communicator 150, and an operation hardware 160, and the respective components are connected one another via a bus 170.

The controller 110 includes, for example, a CPU (Central Processing Unit), and controls the whole information providing apparatus 100.

The ROM 120 is a non-volatile memory that stores a program and various data to control the whole information providing apparatus 100 by the controller 110.

The RAM 130 is a volatile memory that temporarily stores information created by the controller 110, and necessary data to create such information.

The display 140 is a display device including, for example, an LCD (Liquid Crystal Display) and a backlight. The display 140 displays, for example, data output by the controller 110 under the control of the controller 110.

The communicator 150 includes a communication interface that connects the information providing apparatus 100 with the Internet 600.

The operation hardware 160 includes input devices, such as a button, a touch panel, and a keyboard. The operation hardware 160 receives an operation input by the user, and outputs an operation input signal corresponding to the received operation input to the controller 110.

Next, an explanation will be given of a functional configuration of the information providing apparatus 100.

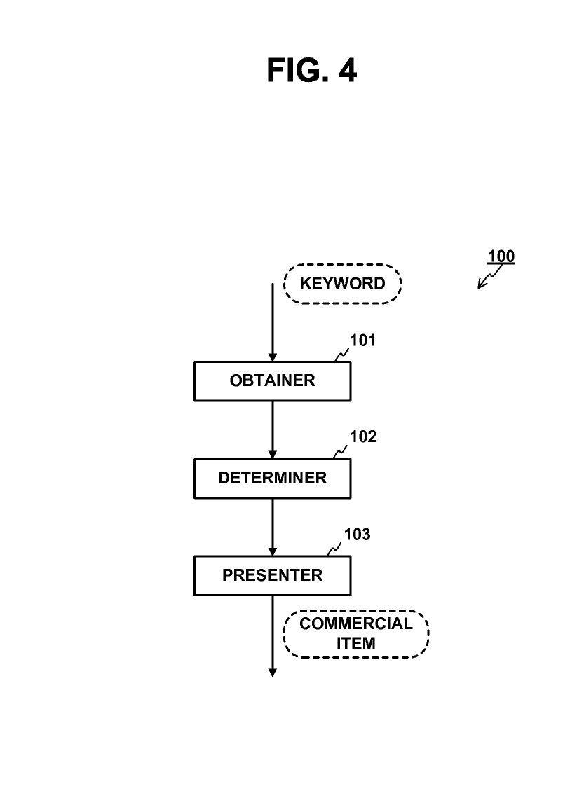

FIG. 4 is a schematic block diagram illustrating a functional configuration of the information providing apparatus 100. As illustrated in FIG. 4, the information providing apparatus 100 includes an obtainer 101, a determiner 102, and a presenter 103.

The obtainer 101 sorts, when a keyword is entered, categories associated with the commercial items matching the keyword in descending order of the number of commercial items associated with the category among the commercial items matching the keyword, and obtains the categories that are equal to or higher than a predetermined ranking.

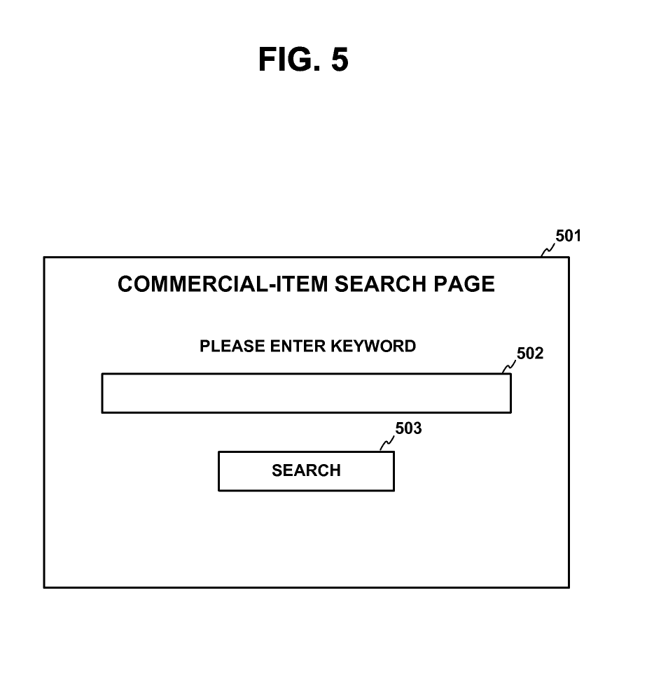

More specifically, the obtainer 101 provides a commercial-item search page to search a commercial item desired by the user of the user terminal 500 from the commercial-item database 200 in response to a request from the user terminal 500. FIG. 5 illustrates an example commercial-item search page 501 provided to the user terminal 500. The commercial-item search page 501 illustrated in FIG. 5 is displayed on the display of the user terminal 500. The user of the user terminal 500 enters a keyword related to a commercial item that the user wants to search from the commercial-item database 200 into an enter form 502 contained in the commercial-item search page 501. Next, when a button 503 is selected by the user of the user terminal 500, the user terminal 500 outputs the keyword that is entered into the enter form 502 to the information providing apparatus 100. Subsequently, the obtainer 101 obtains, from the user terminal 500, the keyword entered by the user of the user terminal 500.

Next, the obtainer 101 specifies, upon obtainment of the keyword from the user terminal 500, commercial items matching the obtained keyword from the commercial-item database 200. Next, the obtainer 101 specifies categories associated with the commercial items for each specified commercial item. When, for example, receiving a keyword that is “gastrointestinal medicine B” from the user terminal 500, the obtainer 101 specifies, from the commercial-item database 200 illustrated in FIG. 2, commercial items matching the “gastrointestinal medicine B” which are commercial items having commercial-item IDs of “G102”, “G301”, and “G401”. Next, the obtainer 101 specifies categories “first-category medicinal items” and “foods” that correspond to the specified commercial-item IDs “G102”, “G301”, and “G401”.

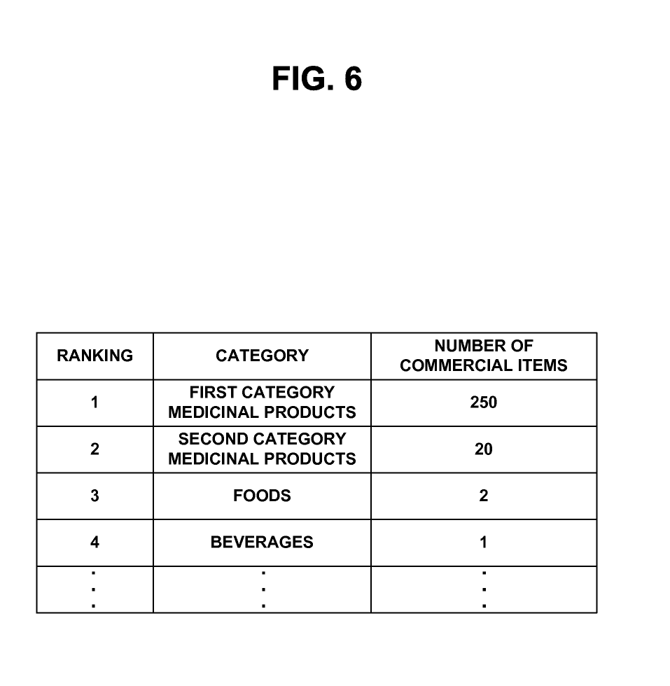

Subsequently, the obtainer 101 sorts the specified categories in descending order of the number of commercial items associated with the category among the specified commercial items. Thereafter, the obtainer 101 obtains, among the sorted categories, the category that is equal to or higher than a predetermined ranking, for example, equal to or higher than the first rank, that is, the category associated with the largest number of commercial items. FIG. 6 illustrates an example sorting result of the categories of the commercial items matching the entered name of commercial item “gastrointestinal medicine B” based on the number of associated commercial items. The obtainer 101 obtains the first rank category “first-category medicinal items” based on the result illustrated in FIG. 6.

According to this embodiment, the controller 110 and the communicator 150 work together to function as the obtainer 101.

The determiner 102 determines whether or not the category obtained by the obtainer 101 satisfies a predetermined condition.

In this case, the predetermined condition is a condition to identify that the commercial item associated with the obtained category is a commercial item that requires a specific credential or license for sale. For example, the store which sells commercial items belonging to the categories “first-category medicinal products” and “liquors” needs to have a specific credential or license for sale in accordance with the laws set forth for those commercial items. Hence, the determiner 102 determines whether or not the category obtained by the obtainer 101 is a category with a limitation for the sales of the commercial items belonging to that category.

More specifically, the determiner 102 determines, for example, whether or not the category obtained by the obtainer 101 matches specific categories recorded in the

ROM 120 in advance. In this case, the specific categories are categories that require a specific credential or license for the sales of the commercial items belonging to those categories, and are recorded in the ROM 120 in advance by the user of the information providing apparatus 100. For example, the categories “first-category medicinal products” and “liquors” are recorded in the ROM 120 as specific categories. Next, when the category obtained by the obtainer 101 matches the specific categories recorded in the ROM 120, the determiner 102 determines that the predetermined condition is satisfied. Conversely, when the category obtained by the obtainer 101 does not match the specific categories recorded in the ROM 120, the determiner 102 determines that the predetermined condition is not satisfied. When, for example, the category obtained by the obtainer 101 is the “first-category medicinal products”, since the “first-category medicinal products” are recorded in the ROM 120 as the specific category, the determiner 102 determines that the predetermined condition is satisfied.

In this embodiment, the controller 110 functions as the determiner 102.

The presenter 103 presents, when the determiner 102 determines that the category obtained by the obtainer 101 satisfies the predetermined condition, the commercial items associated with the category that is equal to or higher than the predetermined ranking among the commercial items matching the keyword that are specified by the obtainer 101.

When, for example, the determiner 102 determines that the category “first-category medicinal products” obtained by the obtainer 101 satisfies the predetermined condition, the presenter 103 presents, to the user terminal 500, the commercial items associated with the category “first-category medicinal products” that is obtained by the obtainer 101 among the commercial items matching the entered keyword “gastrointestinal medicine B”.

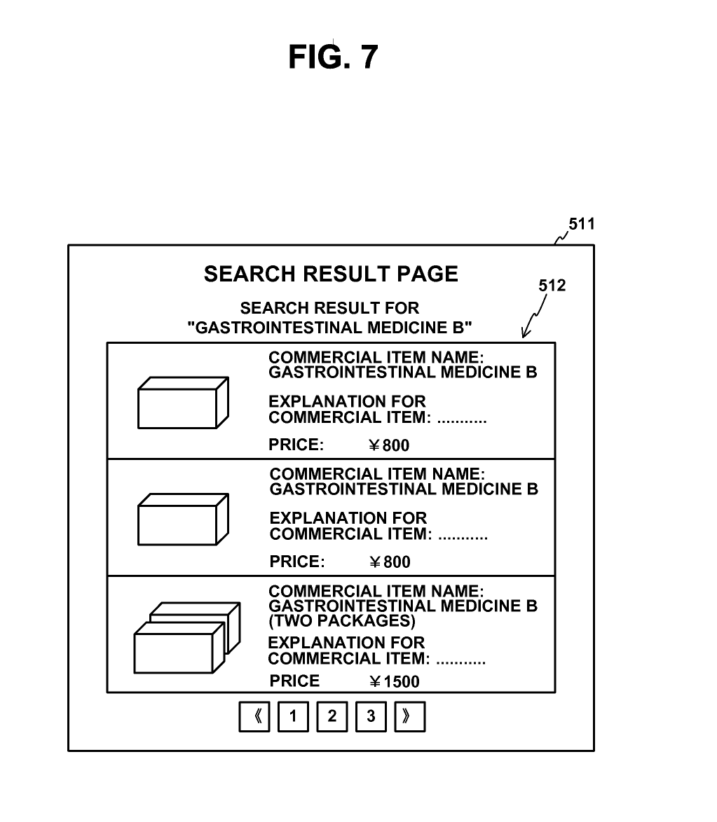

FIG. 7 illustrates an example search result page 511 provided to the user terminal 500 by the presenter 103. The search result page 511 illustrated in FIG. 7 is displayed on the display of the user terminal 500. The search result page 511 contains a search result list 512 that is a list of commercial items matching the entered keyword “gastrointestinal medicine B”. When the user of the user terminal 500 selects one of the commercial items displayed in the search result list 512, the search result page 511 jumps to a page that describes the detailed explanation of the selected commercial items.

When the determiner 102 determines that the category “first-category medicinal products” obtained by the obtainer 101 satisfies the predetermined condition, the presenter 103 lists up the commercial items associated with the category “first-category medicinal products” that is obtained by the obtainer 101 among the commercial items matching the entered keyword “gastrointestinal medicine B” to create the search result list 512, and provides the list to the user terminal 500.

That is, the presenter 103 does not present, to the user terminal 500, the commercial item which matches the keyword “gastrointestinal medicine B” but is not associated with the category “first-category medicinal products” obtained by the obtainer 101. For example, in the commercial-item database 200 illustrated in FIG. 2, the commercial item having a commercial-item ID that is “G401” has the commercial-item name “gastrointestinal medicine B”, thus matching the keyword “gastrointestinal medicine B”. However, the category “foods” associated with the commercial item which has the commercial-item ID of “G401” does not match the category “first-category medicinal products” obtained by the obtainer 101. Hence, the presenter 103 does not include this commercial item in the search result list 512, and does not present this commercial item to the user terminal 500.

According to this embodiment, the controller 110 and the communicator 150 work together to function as the presenter 103.

Next, an explanation will be given of an operation of the information providing apparatus 100 according to this embodiment.

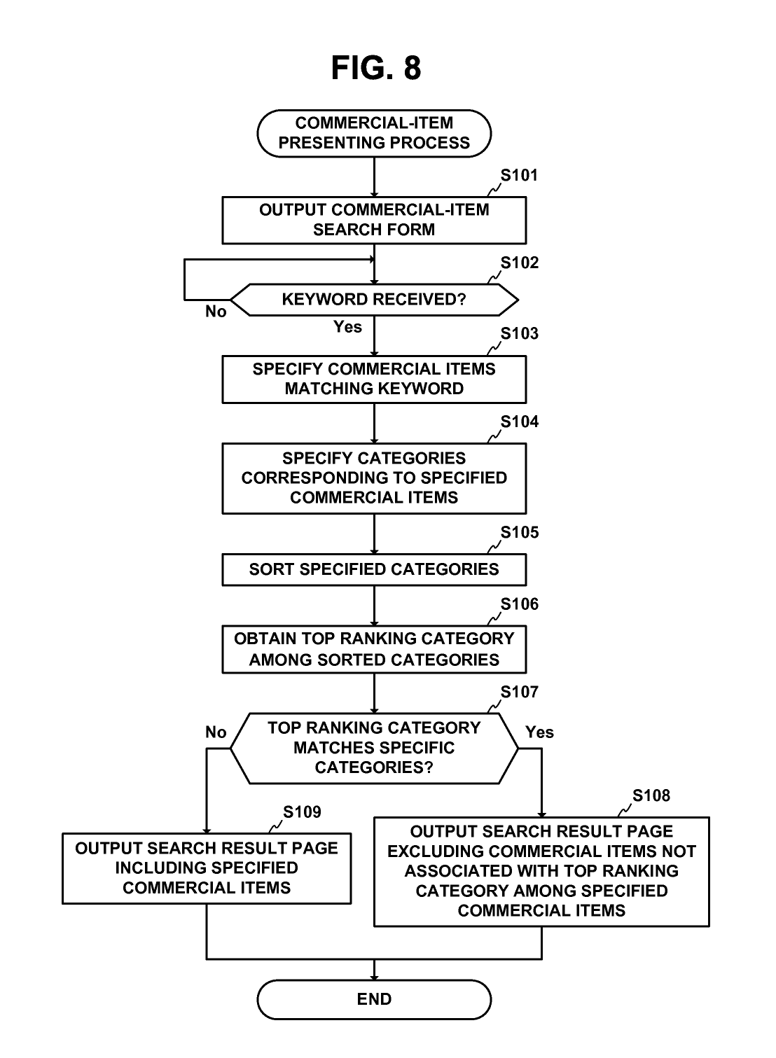

A commercial-item presenting process executed by the controller 110 of the information providing apparatus 100 will now be explained. FIG. 8 is an example flowchart of the commercial-item presenting process. The commercial-item presenting process illustrated in FIG. 8 is started upon acceptance of an inputting from the user terminal 500 indicating a request of a commercial-item search page. In addition, this process is, for example, executed by the CPU of the controller 110 which reads the program stored in the ROM 120.

The obtainer 101 outputs the commercial-item search form 501 illustrated in FIG. 5 to the user terminal 500 (step S101).

Next, the obtainer 101 determines whether or not a keyword has been received from the user terminal 500 (step S102). The obtainer 101 stands by until it is determined that the keyword has been received (step S102: No). Upon selection of the “search” button 503 by the user, the user terminal 500 outputs the keyword entered into the enter form 502 to the information providing apparatus 100.

When determining that the keyword has been received from the user terminal 500 (step S102: Yes), the obtainer 101 specifies commercial items that match the keyword from the commercial-item database 200 (step S103).

Next, the obtainer 101 specifies, for each commercial item specified in the step S103, a category associated with each commercial item (step S104).

Subsequently, the obtainer 101 sorts the categories specified in the step S104 in descending order of the number of commercial items associated with those categories among the commercial items specified in the step S103 (step S105).

Thereafter, the obtainer 101 obtains the top ranking category among the categories sorted in the step S105 (step S106).

Next, the determiner 102 determines whether or not the category obtained in the step S106 matches the specific categories recorded in the ROM 120 (step S107).

When the determiner 102 determines that the category obtained in the step S106 matches the specific categories (step S107: Yes), the presenter 103 outputs, to the user terminal 500, the search result page 511 including the commercial items other than the commercial items not associated with the category obtained in the step S106 among the commercial items specified in the step S103 (step S108). Thereafter, this process is terminated.

When the determiner 102 determines that the category obtained in the step

S106 does not match the specific categories (step S107: No), the presenter 103 outputs the search result page 511 including the commercial items specified in the step S103 to the user terminal 500 (step S109). Thereafter, this process is terminated.

As explained above, the information providing apparatus 100 of this embodiment specifies commercial items corresponding to the entered keyword from the commercial-item database 200 when the user of the user terminal 500 enters the keyword. Next, when a category having a large number of associated commercial items satisfies the predetermined condition among the categories of the specified commercial items, the information providing apparatus 100 presents, to the user terminal 500, the commercial items associated with that category among the commercial items corresponding to the entered keyword.

It is typical that information on a commercial item registered in the commercial-item database 200 is properly input by a store which sells that commercial item unless this store intentionally inputs false information or the store makes a mistake. This is because, if information on the commercial item is not properly registered in the commercial-item database 200, when the user who attempts to purchase this commercial item searches the commercial item in the commercial-item database 200 using a keyword, such a keyword does not match the information on the commercial item, and thus the commercial item is highly possibly excluded from the search result. Hence, exclusion of the commercial item from the search result leads the store which sells the commercial item to lose many opportunities to sell the commercial items.

Accordingly, the commercial item associated with a category B that is different from a category A which is a major category among the commercial items matching the entered keyword is highly possibly registered falsely in the commercial-item database 200 in association with the category B by the store which sells the commercial item. The information providing apparatus 100 of this embodiment presents, to the user terminal 500, the commercial item associated with the category A, but does not present, to the user terminal 500, the commercial item associated with the category B, thereby preventing, a presentation of, to the user, the commercial item having false information input thereof.

In addition, the information providing apparatus 100 of this embodiment presents, when a commercial item which belongs to a category that is a major category among the commercial items matching the entered keyword requires a specific credential or license for sale, the commercial item associated with this category to the user terminal 500.

When a commercial item belonging to a category requires a specific credential or license for the sales of the commercial item, the manager who manages the information on the commercial item registered in the commercial-item database 200 typically pays attention more so than with other categories to ensure that the information on the commercial item registered in association with that category does not contains any errors. Hence, when a store which has no such specific credential attempts to sell the commercial item belonging to this category, the commercial item is highly possibly registered in the commercial-item database 200 in association with a different category from that category. When a category that is a major category among the commercial items matching the entered keyword is a category that requires a specific credential for sale, the information providing apparatus 100 of this embodiment presents only the commercial item associated with that category to the user terminal 500, thereby preventing a presentation of a commercial item associated with a false category to the user.

The embodiment of the present disclosure was explained above, but the present disclosure is not limited to the aforementioned embodiment. Modified examples of the embodiment will be explained below. In the following modified examples, the same structure as that of the aforementioned embodiment will be denoted by the same reference numeral, and the detailed explanation thereof will be omitted.

### MODIFIED EXAMPLES

In the above-explained embodiment, the information providing apparatus 100 sorts the categories associated with the commercial items matching the entered keyword to obtain a category that is equal to or higher than a predetermined ranking, and presents the commercial item associated with the category that is equal to or higher than the predetermined ranking among the commercial items matching the entered keyword when the obtained category satisfies the predetermined condition. However, the information providing apparatus 100 may utilize, instead of the category, the seller (store) of the commercial item in the above-explained processes.

That is, the information providing apparatus 100 may sort, likewise the above-explained embodiment, stores associated with the commercial items matching the entered keyword to obtain a store that is equal to or higher than a predetermined ranking, and may present the commercial item associated with the store that is equal to or higher than the predetermined ranking among the commercial items matching the entered keyword when the obtained store satisfies a predetermined condition. In this case, a determination on whether or not the predetermined condition is satisfied may be carried out based on, for example, whether or not the store obtained by the obtainer 101 matches specific stores recorded in the ROM 120 in advance. The specific stores are stores which have a specific credential or license to sell the commercial items, and which are recorded in the ROM 120 in advance by the users of the information providing apparatus 100. As explained above, the use of the attribute of the commercial item, such as a category or a seller, stored in the commercial-item database 200 for each commercial item, makes it possible to determine which one of the commercial items matching the entered keyword should be presented to the user terminal 500.

In the above-explained embodiment, the program executed by the information providing apparatus 100 may be stored in and distributed with a computer-readable non-transitory recording medium, such as a flexible disk, a CD-ROM (Compact Disk Read-Only Memory), a DVD (Digital Versatile Disk), or an MO (Magneto-Optical Disk). Such a program may be installed in an information processing apparatus like a personal computer to construct the information providing apparatus 100 that executes the above-explained processes.

In addition, the program may be stored in a disk device, etc., of a predetermined server apparatus over a communication network like the Internet. In addition, the program may be superimposed on, for example, carrier waves for downloading.

Still further, when the above-explained functions are realized in a manner shared by an OS (Operating System) or is realized by cooperative operations of the OS with an application, only the program portion other than a portion realizing the functions of the OS may be stored in and distributed with a non-transitory recording medium, and may be downloaded.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is applicable to electronic commerce utilizing a network like the Internet.

### REFERENCE SIGNS LIST

1 Information processing system

100 Information providing apparatus

101 Obtainer

102 Determiner

103 Presenter

110 Controller

120 ROM

130 RAM

140 Display

150 Communicator

160 Operation hardware

170 Bus

200 Commercial-item database

300 Commercial-item registering apparatus

400 Store terminal

500 User terminal

501 Commercial-item search page

502 Enter form

503 Button

511 Search result page

512 Search result list

600 Internet

1. An information providing apparatus comprising:
an obtainer that sorts, when a keyword is entered, attributes associated with commercial items matching the keyword in descending order of the number of commercial items associated with the attributes among the commercial items matching the keyword to obtain an attribute that is equal to or higher than a predetermined ranking;
a determiner that determines whether or not the obtained attribute satisfies a predetermined condition; and
a presenter that presents the commercial item associated with the attribute that is equal to or higher than the predetermined ranking among the commercial items matching the keyword when the determiner determines that the obtained attribute satisfies the predetermined condition,
wherein when the commercial item associated with the obtained attribute requires a specific credential to sell the commercial item, the determiner determines that the attribute that is equal to or higher than the predetermined ranking satisfies the predetermined condition.

2. (canceled)

3. The information providing apparatus according to claim 1, wherein the presenter does not present the commercial item of a seller that does not have the specific credential among the commercial items matching the keyword.

4. The information providing apparatus according to claim 1, wherein the presenter does not present the commercial items associated with the attributes other than the attribute that is equal to or higher than the predetermined ranking among the obtained commercial items.

5. The information providing apparatus according to claim 1, wherein the attribute indicates a category where the commercial item belongs.

6. The information providing apparatus according to claim 1, wherein the attribute indicates a seller of the commercial item.

7. An information providing method executed by an information processing apparatus comprising an obtainer, a determiner, and a presenter, the method comprising:
an obtaining step of causing the obtainer to sort, when a keyword is entered, attributes associated with commercial items matching the keyword in descending order of the number of commercial items associated with the attributes among the commercial items matching the keyword to obtain an attribute that is equal to or higher than a predetermined ranking;
a determining step of causing the determiner to determine whether or not the obtained attribute satisfies a predetermined condition; and
a presenting step of causing the presenter to present the commercial item associated with the attribute that is equal to or higher than the predetermined ranking among the commercial items matching the keyword when the determiner determines that the obtained attribute satisfies the predetermined condition,
wherein in the determining step, when the commercial item associated with the obtained attribute requires a specific credential to sell the commercial item, the determiner determines that the attribute that is equal to or higher than the predetermined ranking satisfies the predetermined condition.

8. (canceled)

9. A computer-readable non-transitory recording medium having stored therein a program that causes a computer to function as:
an obtainer that sorts, when a keyword is entered, attributes associated with commercial items matching the keyword in descending order of the number of commercial items associated with the attributes among the commercial items matching the keyword to obtain an attribute that is equal to or higher than a predetermined ranking;
a determiner that determines whether or not the obtained attribute satisfies a predetermined condition; and
a presenter that presents the commercial item associated with the attribute that is equal to or higher than the predetermined ranking among the commercial items matching the keyword when the determiner determines that the obtained attribute satisfies the predetermined condition,
wherein when the commercial item associated with the obtained attribute requires a specific credential to sell the commercial item, the determiner determines that the attribute that is equal to or higher than the predetermined ranking satisfies the predetermined condition.

10. The information providing method according to claim 7, wherein in the presenting step, the presenter does not present the commercial item of a seller that does not have the specific credential among the commercial items matching the keyword.

11. The information providing method according to claim 7, wherein in the presenting step, the presenter does not present the commercial items associated with the attributes other than the attribute that is equal to or higher than the predetermined ranking among the obtained commercial items.

12. The information providing method according to claim 7, wherein the attribute indicates a category where the commercial item belongs.

13. The information providing method according to claim 7, wherein the attribute indicates a seller of the commercial item.

14. A computer-readable non-transitory recording medium according to claim 9, wherein the presenter does not present the commercial items of a seller that does not have the specific credential among the commercial items matching the keyword.

15. A computer-readable non-transitory recording medium according to claim 9, wherein the presenter does not present the commercial items associated with the attributes other than the attribute that is equal to or higher than the predetermined ranking among the obtained commercial items.

16. A computer-readable non-transitory recording medium according to claim 9, wherein the attribute indicates a category where the commercial item belongs.

17. A computer-readable non-transitory recording medium according to claim 9, wherein the attribute indicates a seller of the commercial item.
